(19) United States
(12) Patent Application Publication
(10) Pub. No.: US 2026/0046621 A1
(43) Pub. Date: Feb. 12, 2026

(54) METHODS, ARCHITECTURES, APPARATUSES, AND SYSTEMS FOR SECURE NON-3GPP ACCESS

(71) Applicant: InterDigital Patent Holdings, Inc., Wilmington, DE (US)

(72) Inventors: Samir Ferdi, Kirkland (CA); Xavier De Foy, Kirkland (CA); Magurawalage Chathura Madhusanka Sarathchandra, London (GB); Zhibi Wang, Woodridge, IL (US); Taimoor Abbas, Sainte-Julie (CA); Guanzhou Wang, Brossard (CA); Rocco Di Girolamo, Laval (CA)

(21) Appl. No.: 18/798,602

(22) Filed: Aug. 8, 2024

(51) Int. Cl. H04W 12/06; H04W 8/22; H04W 12/043; H04W 76/10

(52) U.S. Cl. CPC H04W 12/068; H04W 8/22; H04W 12/043; H04W 76/10

(57) ABSTRACT

A process for establishing a secure non-3GPP connection between a wireless transmit and/or receive unit (WTRU) and a wireless network using existing 3GPP access credentials. The WTRU transmits a request to establish a protocol data unit (PDU) session along with secure non-3GPP information to the wireless network. Upon receiving an acceptance indication, the WTRU generates new security credentials based on the existing 3GPP credentials and establishes the secure non-3GPP connection. Provisions are made for indicating 3GPP security capability of the secure non-3GPP connection, standalone non-3GPP connections, and secure connection termination at the user plane function (UPF). Additionally, new shared keys are generated for secure non-3GPP connectivity and handling handovers with updated 3GPP access credentials. The process ensures secure communication between the WTRU and the wireless network by leveraging security frameworks.

### TECHNICAL FIELD

The present disclosure is generally directed to the fields of communications, hardware, software and encoding, including, for example, to methods, architectures, apparatuses and systems related to non-3GPP access.

### BACKGROUND

The 3GPP TS 23.501 v19.0.0 specification outlines the architecture for the 5G System (5GS), detailing the network functions and interfaces required for its operation, while 3GPP TS 23.502 v19.0.0 describes the procedures for 5GS, including session and mobility management, and policy control. 3GPP TR 23.700-54 v1.0.0 explores multi-access technologies like DualSteer and Access Traffic Steering-Switching-Splitting (ATSSS) Phase 4, focusing on their integration and enhancements within the 5G system, and 3GPP TR 33.754 v0.2.0 addresses the security aspects of these technologies, proposing solutions to potential security challenges. IETF RFC 5996 details version 2 of the Internet Key Exchange (IKE) protocol, a key component of Internet Protocol Security (IPsec) for mutual authentication and establishing Security Associations, while IETF RFC 8446 specifies version 1.3 of the Transport Layer Security (TLS) protocol, enhancing security and performance for internet communications. Lastly, 3GPP TS 24.526 v18.7.0 defines the policies for User Equipment (UE) in the 5G System, covering route selection, access network discovery, and selection to ensure efficient and secure connectivity for 5G devices.

### SUMMARY

In certain representative embodiments, a method is performed by a wireless transmit and/or receive unit (WTRU), for configuring a secure non-3GPP connection with a wireless network using existing 3GPP access credentials. For example, the secure non-3GPP connection is made directly (e.g., without going through a non-3GPP Inter-Working Function (N3IWF)) to a user plane function (UPF) of the wireless network. Also, for example, the method includes at least one of initiation, acceptance, security credentials generation, connection establishment, combinations of the same, or the like. Further, for example, the WTRU transmits a request to the wireless network to establish a protocol data unit (PDU) session, including information for enablement of the secure non-3GPP connection for the PDU session. In addition, for example, the wireless network responds with an acceptance of the secure non-3GPP connection enablement for the PDU session. Moreover, for example, upon acceptance, the WTRU generates new security credentials for the non-3GPP connection based on the existing 3GPP access credentials. Furthermore, for example, the WTRU establishes the secure non-3GPP connection for the PDU session with the wireless network using the new security credentials. Additionally, for example, the initial request indicates the WTRU's 3GPP security capability for the secure non-3GPP connection and supported security protocols. Still further, for example, the acceptance response indicates the termination of the secure non-3GPP connection at the UPF of the wireless network and the supported security protocols. Even further, for example, new security credentials include generating a new shared key for secure non-3GPP connectivity and the new shared key identifier based on a shared key of a network node (KgNB). Yet further, during handover between network nodes, the WTRU receives updated 3GPP access credentials and generates updated security credentials for the secure non-3GPP connection.

In certain representative embodiments, a method is performed at a user plane function (UPF) in a wireless network for configuring a secure non-3GPP connection with a WTRU using existing 3GPP access credentials. For example, the secure non-3GPP connection is made directly to the UPF of the wireless network. Also, for example, the method includes at least one of request reception, acceptance transmission, security credentials reception, connection establishment, combinations of the same, or the like. Further, for example, the UPF receives a request from a session management function (SMF) to establish a data path for a PDU session, including secure non-3GPP connection information. In addition, for example, the UPF transmits a session establishment response to the SMF with an acceptance indication for the secure non-3GPP connection enablement for the PDU session. Moreover, for example, the UPF receives new security credentials for the secure non-3GPP connection, based on the existing 3GPP access credentials, either directly from a gNB or via the SMF. Furthermore, for example, the UPF establishes the secure non-3GPP connection with the WTRU using the new security credentials. Additionally, for example, the initial request indicates the WTRU's 3GPP security capability for the secure non-3GPP connection and supported security protocols. Still further, for example, the acceptance response indicates the termination of the secure non-3GPP connection at the UPF and the supported security protocols. Even further, for example, new security credentials include generating a new shared key for secure non-3GPP connectivity and the new shared key identifier based on a shared KgNB. Yet further, for example, during handover between network nodes, the UPF receives updated 3GPP access credentials and generates updated security credentials for the secure non-3GPP connection.

In certain representative embodiments, a WTRU is configured to establish a secure non-3GPP connection with a wireless network. For example, the secure non-3GPP connection is made directly to the UPF of the wireless network. Also, for example, the WTRU includes at least one of a processor, a transceiver, combinations of the same, or the like. Further, for example, the WTRU performs at least one of requesting transmission, accepting reception, generating security credentials, establishing a connection, combinations of the same, or the like. In addition, for example, the WTRU includes a processor and a transceiver. Moreover, for example, the WTRU transmits a request to the wireless network to establish a PDU session, including information for enablement of the secure non-3GPP connection for the PDU session. Furthermore, for example, the WTRU receives an acceptance indication from the wireless network for the secure non-3GPP connection enablement. Additionally, for example, based on the acceptance, the WTRU generates new security credentials for the secure non-3GPP connection enablement using existing 3GPP access credentials. Still further, for example, the WTRU establishes the secure non-3GPP connection for the PDU session with the wireless network using the new security credentials. Even further, for example, the initial request indicates the WTRU's 3GPP security capability for the secure non-3GPP connection and supported security protocols. Yet further, for example, the acceptance response may indicate the termination of the secure non-3GPP connection at the UPF and the supported security protocols. For example, new security credentials include generating a new shared key for secure non-3GPP connectivity and the new shared key identifier based on a shared KgNB. Also, for example, during handover between network nodes, the WTRU receives updated 3GPP access credentials and generates updated security credentials for the secure non-3GPP connection.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of non-roaming architecture for a 5G Core Network with untrusted non-3GPP access;

FIG. 3 is a diagram illustrating an example of a simplified ATSSS architecture with a secure non-3GPP leg;

FIG. 4 is a diagram illustrating an example of distribution of keys for secure non-3GPP connection in a local breakout or non-roaming scenario;

FIG. 5 is a diagram illustrating an example of distribution of keys for secure non-3GPP connection in a roaming with secure non-3GPP direct connection to home scenario;

FIG. 6 is a diagram illustrating an example of a key hierarchy for secure non-3GPP connection;

FIG. 7A is a first portion of a sequence diagram illustrating a first portion of an example of a secure non-3GPP connection security setup using 3GPP Access Security;

FIG. 7B is a second portion of the sequence diagram illustrating a second portion of the example of the secure non-3GPP connection security setup using the 3GPP Access Security;

FIG. 8A is a first portion of a sequence diagram illustrating a first portion of an example of a secure non-3GPP security update during an inter-gNB handover;

FIG. 8B is a second portion of the sequence diagram illustrating a second portion of the example of the secure non-3GPP security update during the inter-gNB handover;

FIG. 9 is a procedural diagram illustrating an example procedure, performed by a wireless transmit and/or receive unit (WTRU), for configuring a secure non-3GPP connection between the WTRU and a wireless network based at least in part on existing 3GPP access credentials shared between the WTRU and the wireless network; and

FIG. 10 is a procedural diagram illustrating an example procedure, performed at a user plane function (UPF) of a wireless network, for configuring a secure non-3GPP connection between a wireless transmit and/or receive unit (WTRU) and the wireless network based at least in part on existing 3GPP access credentials shared between the WTRU and the wireless network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

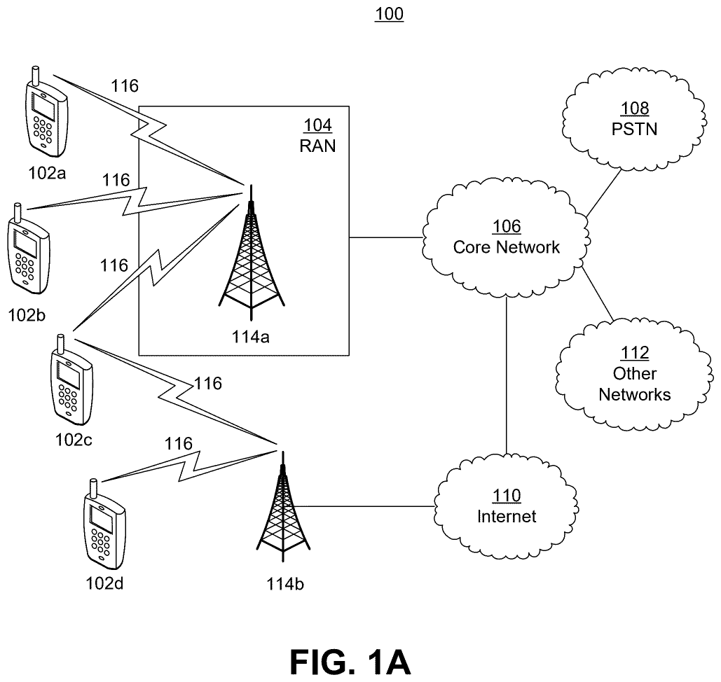

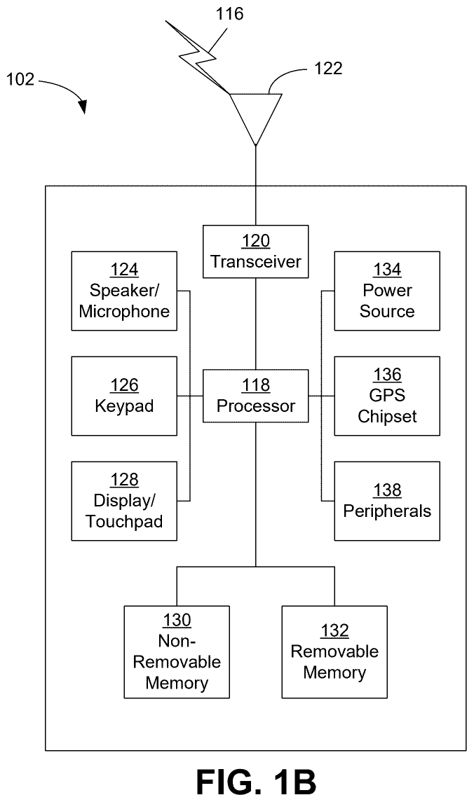

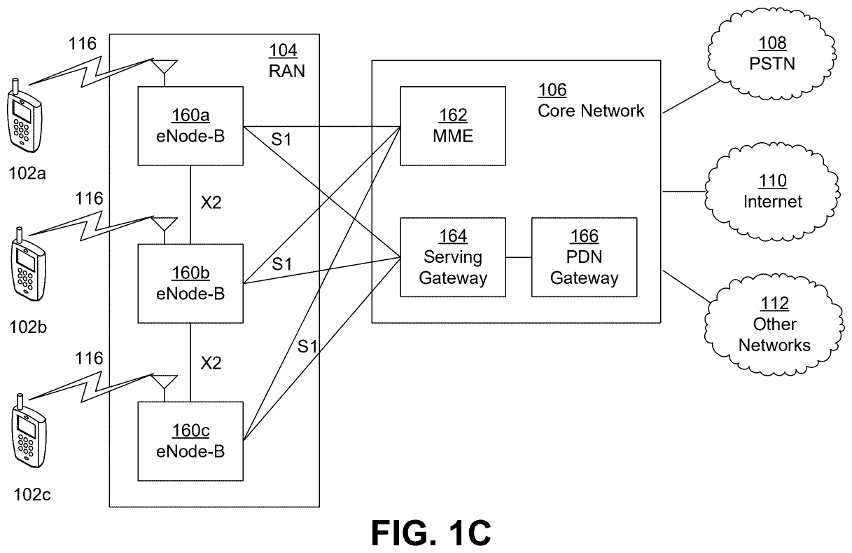

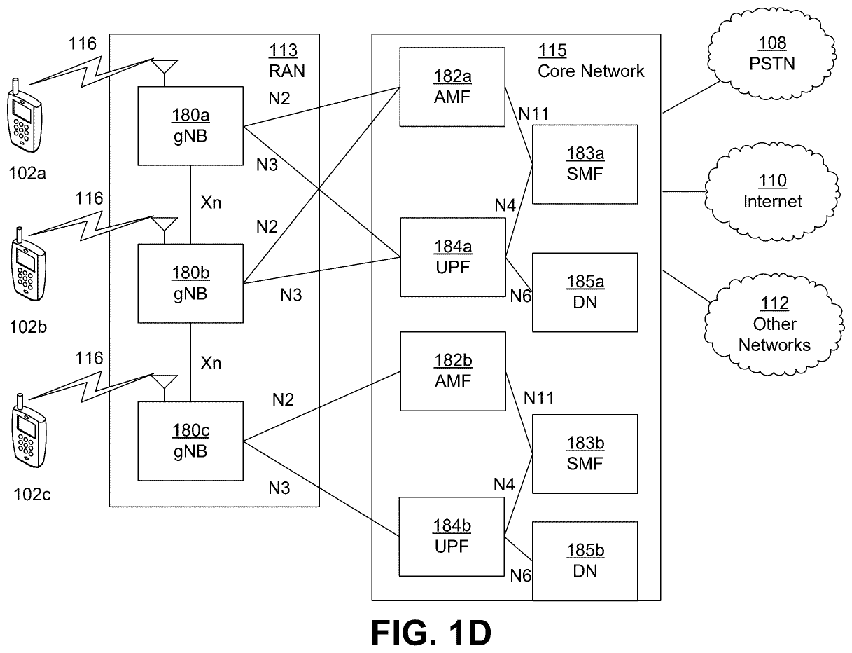

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in in 802.11 systems. For CSMA/CA, the STAs (e.g., every STA), including the AP, may sense the primary channel. If, for example, the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and a transmitting STA may transmit the data. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if, for example, the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If, for example, the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the evolving landscape of wireless technology, Multi-Access Session Steering and Switching (MASSS) enhances connectivity. MASSS involves establishment of PDU sessions over 3GPP access and secure non-3GPP connection, e.g., non-integrated, non-3GPP access (NIN3A). Uses of terms such as NIN3A or the like herein are intended to be exemplary, not limiting, and include application to one or more connections that would not otherwise have (e.g., integrated) security. For example, a secure connection is provided for a connection between a WTRU and a UPF that would not otherwise have security. Such connections that would not otherwise have security include, in some example, NIN3A. The 5G System (5GS) enables secure network access for a WTRU via, e.g., NIN3A, allowing the WTRU to establish a direct, secure connection with the UPF using an intermediate network function (e.g., a non-3GPP Interworking Function, such as N3 Interworking Function (N3IWF)) thus bypassing intermediate network functions. This secure connection is facilitated by credentials derived from 3GPP access, such as KNIN3A, which is generated during PDU session establishment. Additionally, during inter-gNB handover procedures, new KNIN3A keys are derived to update the security of the NIN3A connection, ensuring continuous and secure communication between the WTRU and UPF.

In certain representative embodiments, NIN3A connection security setup using 3GPP access security involves establishing a secure connection during a PDU session between a WTRU and a wireless network. For example, the NIN3A connection security setup includes at least one of WTRU initialization, request to network, network response, key generation, secure connection establishment, combinations of the same, or the like. Also, for example, the WTRU uses its existing 3GPP access security association (e.g., KgNB) to generate a shared security KNIN3A for a direct connection with the UPF over NIN3A. Further, for example, the WTRU sends a request to the wireless network to establish a PDU session with the wireless network and secure NIN3A connection support. In addition, for example, the request includes at least one of an indication of the 3GPP utilized NIN3A security capability (e.g., supported security protocols), an indication of a standalone NIN3A connection, a PDU session identifier (ID), combinations of the same, or the like. Moreover, for example, the SMF responds with at least one of an acceptance indication for the secure NIN3A connection for the specified PDU session ID, addressing information for the secure NIN3A connection termination at the UPF (e.g., IP address, port number), an indication of the security protocols selected and/or supported by the wireless network, combinations of the same, or the like. Furthermore, for example, upon acceptance of the secure NIN3A connection, the WTRU generates a new KNIN3A and KNIN3A ID using KgNB and other input parameters (e.g., PDU session ID, a shared number and/or counter value with the gNB). Additionally, for example, the WTRU establishes a secure connection with the UPF over NIN3A by at least one of performing mutual authentication with the UPF (e.g., via gNB), deriving session and security keys based on KNIN3A using the indicated security protocol (e.g., TLS or IKEv2 with KNIN3A as the pre-shared key (PSK)), transmitting the KNIN3A ID in the initial message between the WTRU and UPF to identify the key for securing the NIN3A session, ensuring the privacy of the WTRU, combinations of the same, or the like. This process ensures a secure and authenticated connection between the WTRU and the wireless network over NIN3A, leveraging existing 3GPP access security mechanisms.

In certain representative embodiments, the UPF is selected by the SMF based on its capability to support a secure NIN3A connection. For example, selection of the UPF by the SMF based on its capability to support a secure NIN3A connection includes at least one of request reception, addressing information, KNIN3A reception, secure connection establishment, combinations of the same, or the like. Also, for example, the UPF receives a request from the SMF to configure an N4 session. This request includes an indication that a secure NIN3A connection is required. Further, for example, the UPF sends addressing information to the SMF. This information, such as an IP address and port number, will be used to terminate the NIN3A connection at the UPF. In addition, for example, the UPF receives the KNIN3A and its associated ID from the gNB (e.g., via the SMF in an N4 session modification) or directly through a new General Packet Radio Service (GPRS) Tunneling Protocol User Plane (GTP-U) message Information Element (IE). Moreover, for example, the UPF establishes a secure connection over NIN3A with the WTRU. This involves performing mutual authentication with the WTRU and generating session and security keys based on the KNIN3A. This process can use protocols like TLS or IKEv2, with the KNIN3A serving as the Pre-Shared Key (PSK). This sequence ensures that the UPF can securely manage the NIN3A connection, maintaining the integrity and confidentiality of the communication between wireless network elements.

In certain representative embodiments, a gNodeB (gNB) provides (e.g., bootstrapping) assistance to establish a secure NIN3A connection by providing a UPF with a KNIN3A, which is utilized based on the existing security association between the WTRU and the gNB (KgNB). For example, the gNB establishing secure NIN3A connection by providing the UPF with the KNIN3A includes at least one of message reception, resource allocation decision, key derivation, key transmission, combinations of the same, or the like. Also, for example, the gNB receives a message from the SMF via the AMF. This message includes the PDU session ID with an indication for secure NIN3A connection support, core network (CN) tunnel information corresponding to the UPF serving the NIN3A session, and an indication of whether it is a standalone NIN3A connection and/or indication whether radio resources should be allocated for the PDU session. Further, for example, if the message indicates a standalone NIN3A connection, the gNB may refrain from allocating resources for user plane data communication over the air interface (e.g., Data Radio Bearer (DRB)) for the PDU session. Based on the indication, the gNB may also refrain from using the N3 interface or restrict its use to network internal “control” messaging, such as the exchange of key material with the UPF, using the GTP-U header or new IEs. In addition, for example, upon receiving the indication for secure NIN3A connection support, the gNB generates a new KNIN3A and its associated ID using the KgNB and other input parameters, such as the PDU session ID and a number or counter value shared with the WTRU. Moreover, for example, the gNB sends the KNIN3A and its ID to the UPF. This can be done directly, for example, in a new GTP-U message IE, or via the AMF and/or SMF, for instance, in an N2 SM information container. This process ensures that the gNB effectively provides assistance to secure the NIN3A connection based on fresh 3GPP credentials, maintaining the integrity and confidentiality of the communication between the WTRU and the UPF.

In certain representative embodiments, SMF is selected by AMF based on its capability to support a PDU session with a secure NIN3A connection. For example, selection of the SMF by the AMF includes at least one of request reception, UPF selection and request, addressing information reception, at least one message to a gNB, combinations of the same, or the like. Also, for example, the SMF receives a request from the WTRU to configure a PDU session with secure NIN3A connection support. This request includes an indication of a standalone NIN3A connection, the supported NIN3A security protocol(s), and the PDU session ID. Further, for example, the SMF selects a UPF that supports a secure NIN3A connection and is compatible with the security protocol(s) supported by the WTRU. The SMF then sends a request to the UPF for N4 session setup, including an indication for secure NIN3A connection and information regarding the usage of the N3 interface with the gNB. In addition, for example, if the WTRU requested a standalone NIN3A connection, the SMF indicates that the N3 interface should not be configured or used for user traffic. Moreover, for example, the request includes a NIN3A connection control policy, outlining rules or criteria for re-authentication of the WTRU and updating the NIN3A connection security. Furthermore, for example, the SMF receives addressing information from the UPF for the NIN3A connection, such as an IP address and port number. Additionally, for example, the SMF sends a message to the gNB via the AMF, which includes the PDU session ID with an indication for secure NIN3A connection support, core network tunnel information corresponding to the UPF serving the NIN3A session, and an indication of whether it is a standalone NIN3A connection and/or an indication of whether radio resources should be allocated for the PDU session. Additionally, for example, the SMF sends a response message to the WTRU, which may be piggybacked in the message to the gNB. This response includes an indication of acceptance for the NIN3A connection for the PDU session and the NIN3A addressing information for the UPF. Still further, for example, the SMF receives a message from the gNB, which includes the KNIN3A and its associated ID. The SMF then forwards this information to the UPF. This sequence ensures that the SMF effectively manages the setup and maintenance of a secure NIN3A connection, maintaining the integrity and confidentiality of the communication between wireless network elements.

In certain representative embodiments, during an inter-gNB handover, NIN3A connection security is updated by a WTRU and UPF following an updated 3GPP access security update. For example, the update of the NIN3A connection security includes at least one of WTRU behavior, UPF behavior, target gNB behavior, SMF behavior, combinations of the same, or the like. Also, for example, when the WTRU receives a radio resource control (RRC) configuration message from the gNB, one or more steps are performed for each PDU session using a secure NIN3A connection. Further, for example, the WTRU generates a new KNIN3A and KNIN3A ID using a new KgNB, which is generated as part of the handover procedure, along with other input parameters such as the PDU session ID and a number or counter value shared with the WTRU. In addition, for example, upon receiving an indication of a security update and/or the new KNIN3A and KNIN3A ID, the UPF performs one or more steps. In addition, for example, based on the NIN3A connection control policy, the UPF determines whether to re-authenticate the WTRU using the new KNIN3A and/or update the NIN3A connection session and security keys. This can be done using specific re-authentication or update methods of the security protocol, such as TLS or IKEv2. Moreover, for example, when the target gNB receives a new KgNB and a list of PDU session information from the source gNB as part of the handover procedure, it performs one or more actions for each PDU session using a secure NIN3A connection. Furthermore, for example, the target gNB generates a new KNIN3A and KNIN3A ID using the new KgNB and other input parameters, such as the PDU session ID and a number or counter value shared with the WTRU. Additionally, for example, the target gNB sends an indication of the security update and/or the new KNIN3A and KNIN3A ID to the serving UPF. This can be done directly or via the AMF and/or SMF, for example, in an N2 Path Switch Request or an Nsmf_PDUSession_UpdateSMContext Request. Still further, for example, the target gNB proceeds with handover completion steps. The target gNB sends the new KNIN3A and KNIN3A ID to the serving UPF directly or via the AMF and/or SMF, ensuring the secure continuation of the NIN3A connection. This process ensures that the NIN3A connection security is maintained and updated appropriately (e.g., based on fresh KgNB) during an inter-gNB handover, preserving the integrity and confidentiality of the communication between WTRU and the UPF.

In certain representative embodiments, NIN3A security updates are provided during inter-gNB handover. For example, NIN3A security updates include at least one of WTRU behavior, UPF behavior, (e.g., Target) RAN node (gNB) behavior, SMF behavior, combinations of the same, or the like. Also, for example, NIN3A connection security is updated by the WTRU and the UPF following an updated 3GPP access security update performed during an inter-gNB (e.g., Xn based) handover procedure. Further, for example, when receiving an RRC configuration message from the gNB, for each PDU session using a secure NIN3A connection, the WTRU generates a new KNIN3A and KNIN3A ID using a new KgNB generated as part of a handoff (HO) procedure, and other input parameters (e.g., PDU session ID, a number and/or counter value shared with the WTRU). In addition, for example, upon receiving the indication of a security update and/or the KNIN3A and KNIN3A ID, based on the NIN3A connection control policy the UPF determines to re-authenticate the WTRU using the new KNIN3A and/or update the NIN3A connection session and/or security keys using the security protocol (e.g., with TLS or IKEv2) specific re-authentication or update methods. Moreover, for example, when receiving a new KgNB and list of PDU session information from a source gNB as part of the HO procedure, for each PDU session using a secure NIN3A connection, the Target gNB generates a new KNIN3A and KNIN3A ID using KgNB and other input parameters (e.g., PDU session ID, a number and/or counter value shared with the WTRU). Furthermore, for example, the Target gNB sends to the serving UPF an indication of the security update and/or the KNIN3A and KNIN3A ID directly or via AMF and/or SMF (e.g., in N2 Path Switch Request, Nsmf_PDUSession_UpdateSMContext Request).

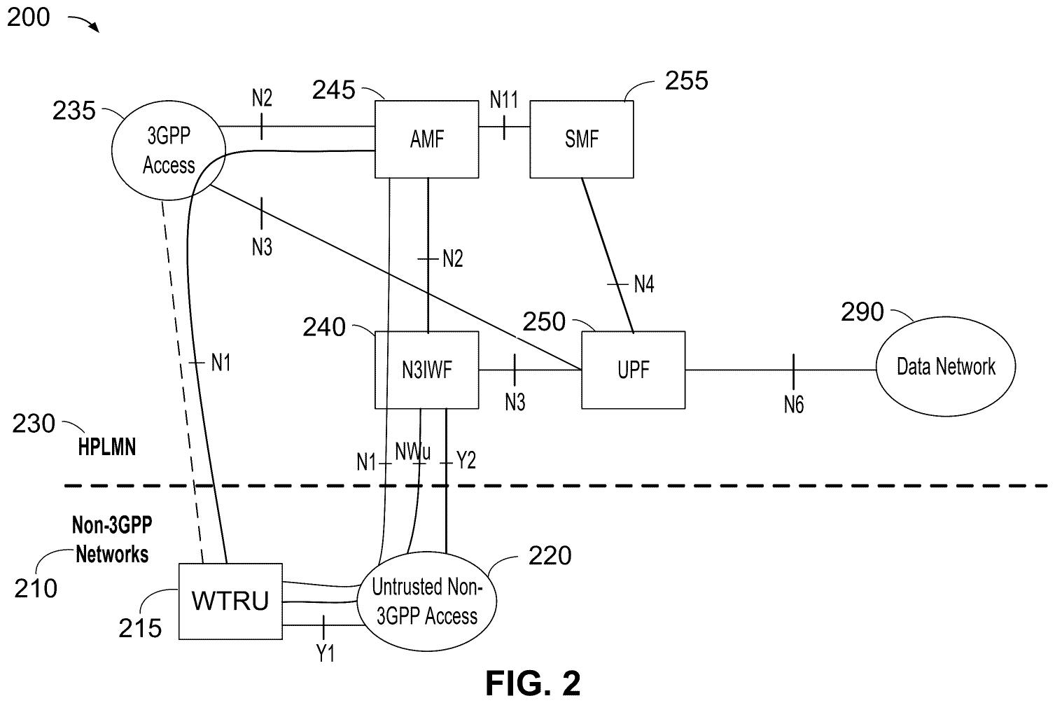

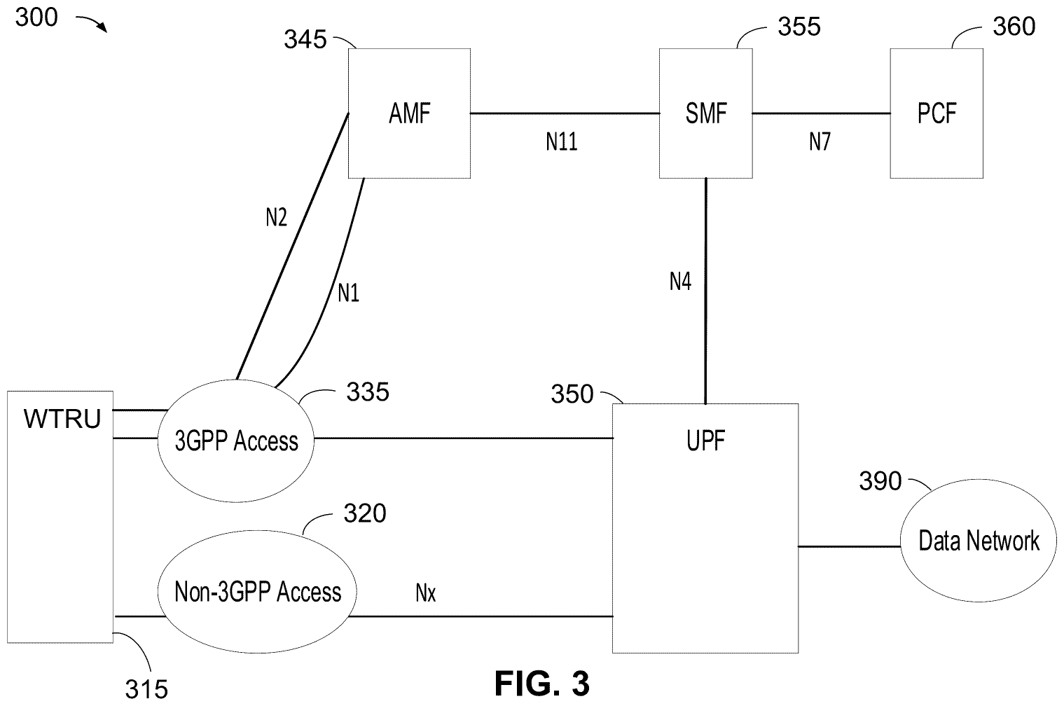

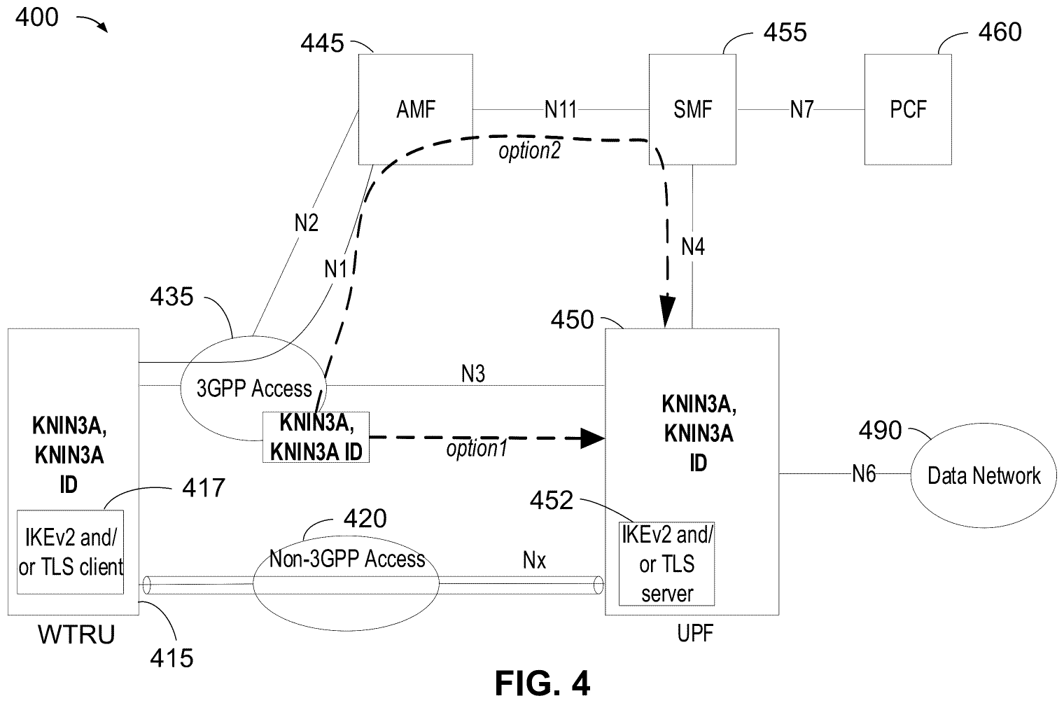

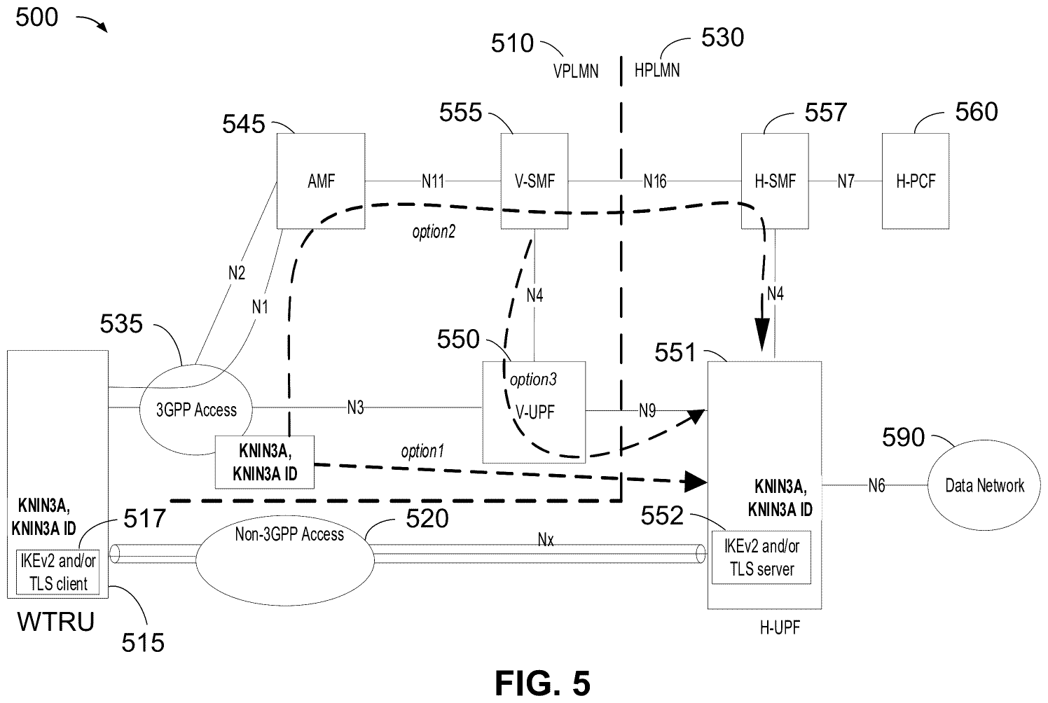

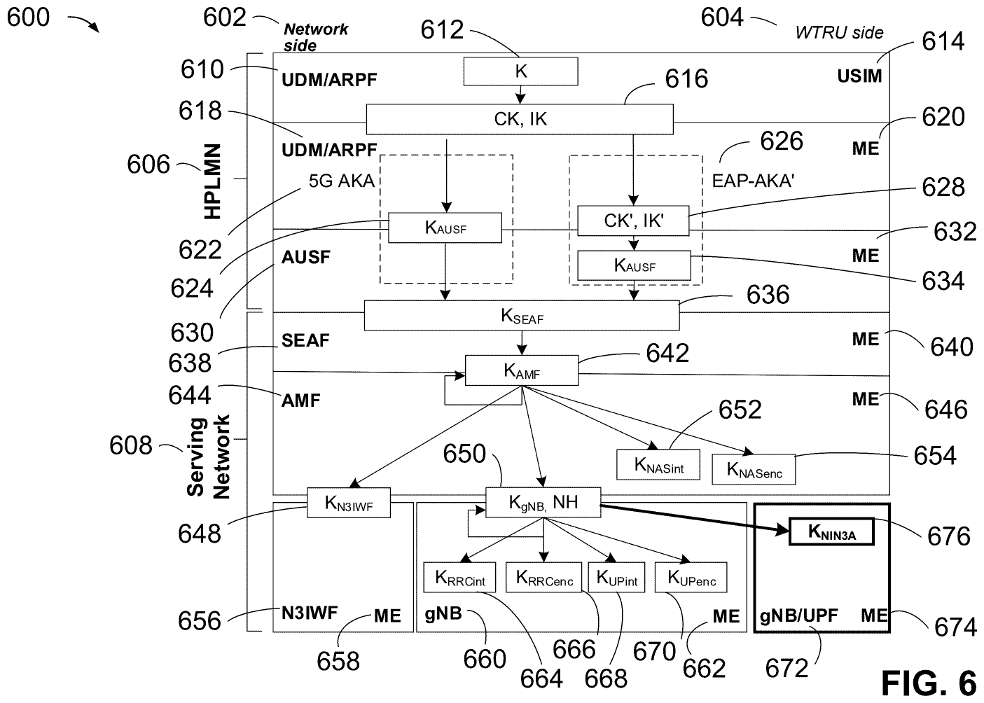

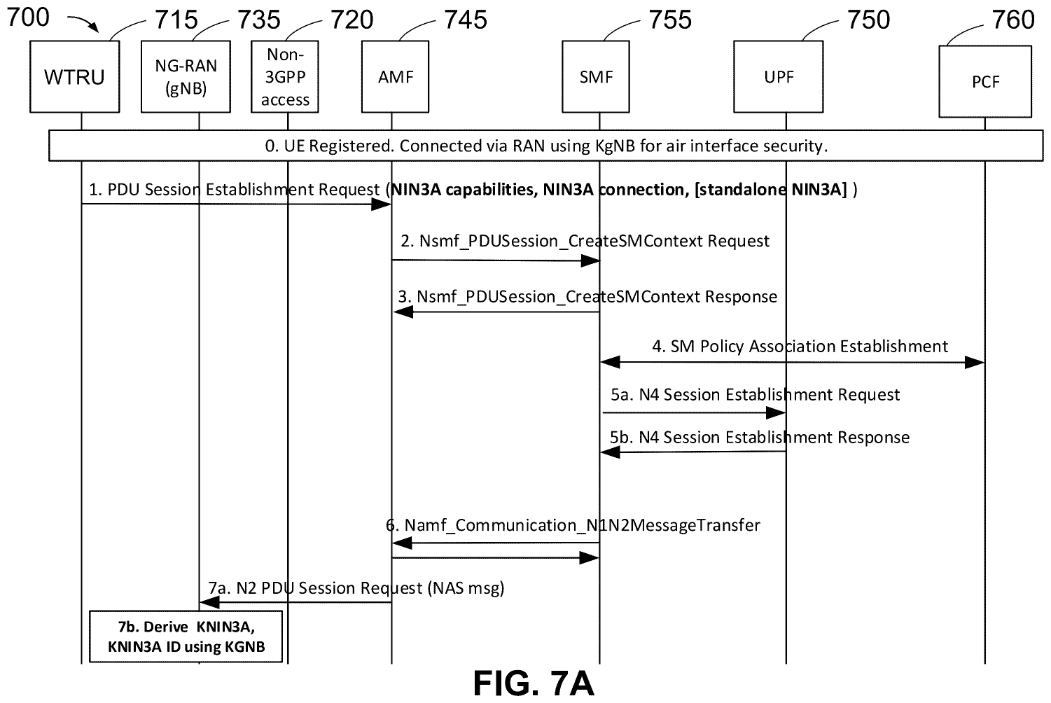

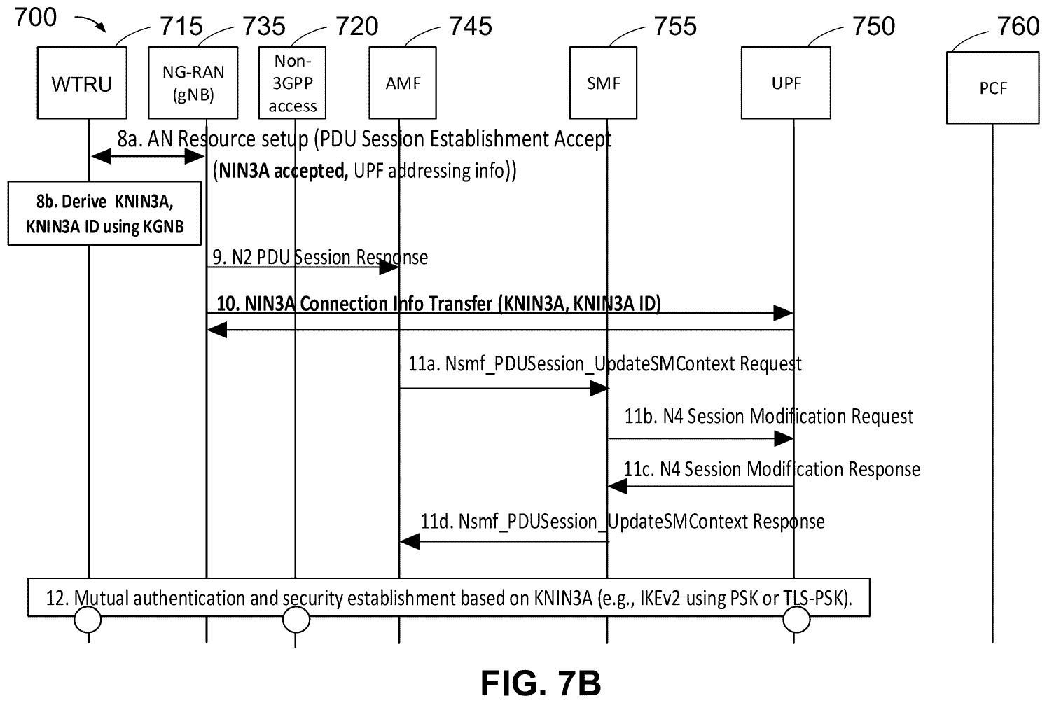

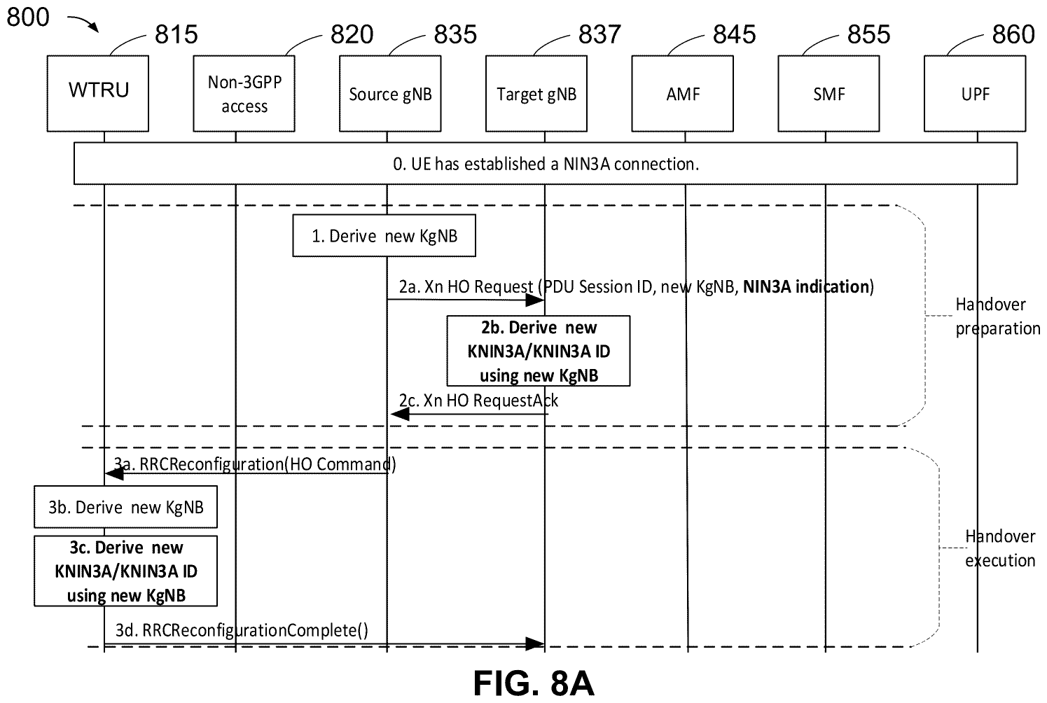

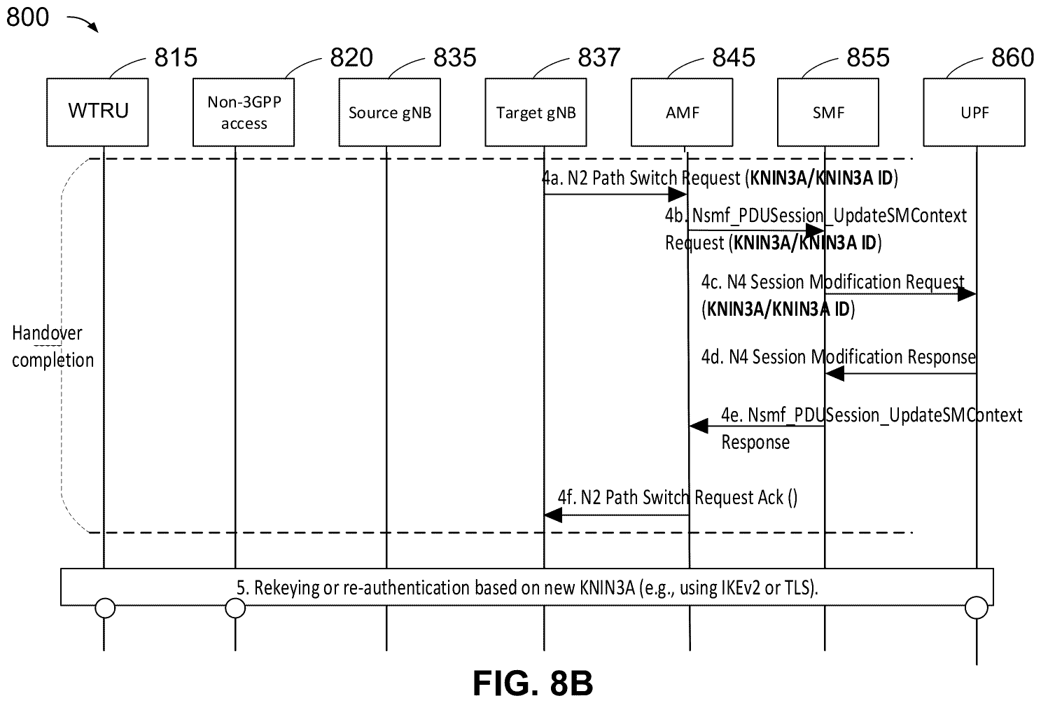

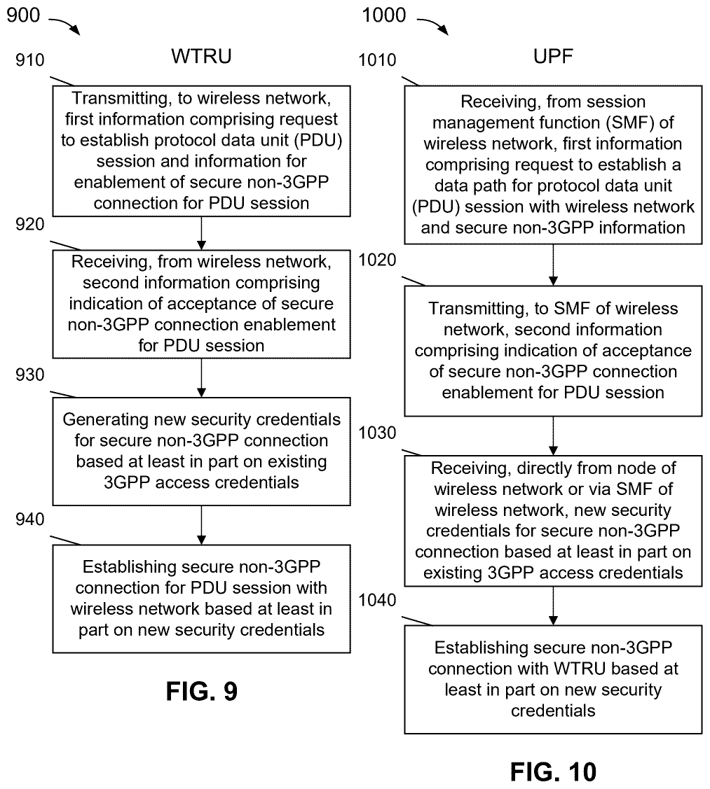

Turning to the detailed description, the following figures illustrate various aspects of non-integrated non-3GPP (NIN3A) connections within, for example, a 5G CN. FIG. 2 depicts a non-roaming architecture with untrusted non-3GPP access, while FIG. 3 shows a simplified ATSSS architecture incorporating a NIN3A leg. FIG. 4 and FIG. 5 detail the distribution of KNIN3A in local breakout and roaming scenarios, respectively. FIG. 6 presents a key hierarchy for NIN3A. FIG. 7A and FIG. 7B provide a sequence diagram for NIN3A connection security setup using 3GPP Access Security. FIG. 8A and FIG. 8B illustrate the security update process during an inter-gNB handover. Finally, FIG. 9 and FIG. 10 outline procedures for configuring a secure NIN3A connection, performed by a wireless transmit and/or receive unit (WTRU) and a user plane function (UPF), respectively, based on existing 3GPP access credentials.

FIG. 2 is a diagram illustrating an example of non-roaming architecture for a 5G Core Network with untrusted non-3GPP access, in accordance with certain representative embodiments. FIG. 2 shows how current 5GS supports Non-3GPP access which is “integrated” by means of an intermediate network function (NF) (e.g., N3IWF, Trusted Non-3GPP Gateway Function (TNGF)), which provides a secure connection (e.g., NWu interface) to a network (e.g., AMF, UPF) for both control plane (CP) and user plane (UP) traffic. For example, a security association between WTRU and the network (e.g., AMF) via untrusted Non-3GPP access is configured using an IPSec tunnel between WTRU and N3IWF to transport a NAS message exchanged as part of a registration procedure.

For example, a system 200 depicts a network architecture related to telecommunications and data networking. The system 200 includes one or more non-3GPP networks 210, such as a WTRU 215 and an untrusted non-3GPP access network 220. For example, the WTRU 215 is connected to the untrusted non-3GPP access network 220 via a Y1 interface. The system 200 includes one or more Home Public Land Mobile Networks (HPLMNs). One or more components of the one or more non-3GPP networks 210 are connected to the HPLMN via interfaces, such as N1, N2, NWu, and Y2. A 3GPP access network 235 includes nodes such as AMF 245, SMF 255, N3IWF 240, and UPF 250. These are connected by interfaces such as N2, N3, N4, N6, and N11. A data network 290 indicates an endpoint for data transmission.

NIN3A is provided, for example, with multi-access technologies like DualSteer and ATSSS Phase 4. An example of simplified ATSSS architecture 300 is illustrated in FIG. 3, whereby a WTRU 315 uses direct IP connectivity towards a UPF 350 (e.g., Nx interface), i.e., with no intermediate NF such as N3IWF.

FIG. 3 is a diagram illustrating an example of a simplified ATSSS architecture with a NIN3A leg, in accordance with certain representative embodiments. FIG. 3 depicts a network architecture 300 related to telecommunications and data networking. The network architecture 300 includes WTRU 315 and non-3GPP access network 320. For example, the WTRU 315 is connected to the non-3GPP access network 320 via an Nx interface. The system 300 includes a 3GPP access network 335, which includes nodes such as AMF 345, SMF 355, UPF 350, and Policy Control Function (PCF) 360. These are connected by interfaces such as N4, N7, and N11. A data network 390 indicates an endpoint for data transmission.

Security of an Nx interface is established based on certificate and/or PSK. For example, the security may be based on a shared key (e.g., KUPF) generated by the WTRU and AMF from KAMF and sent to UPF by AMF directly or via SMF, during PDU session establishment procedure.

Support for “integrated” N3GPP access architecture adds significant complexity to the 5GS. This support requires operators to deploy a dedicated secure gateway functionality (e.g., N3IWF), which introduces overhead and redundancy with 3GPP access control procedures (e.g., registration, primary authentication). Additionally, it necessitates maintaining an extra WTRU security context for N3GPP access in the network. Furthermore, deploying N3IWF requires operators to manage certificates (e.g., deployment, renewal, revocation) needed for WTRU authentication of the N3IWF, and to configure WTRUs to select an N3IWF (e.g., using Access Network Discovery and Selection Policy (ANDSP) rules).

Solutions for NIN3A are defined within the specific scope of ATSSS scenarios (e.g., assuming ATSSS and/or Multi-Access (MA) PDU capabilities and/or usage). It is desirable to support NIN3A with security mechanisms using different transport protocols (e.g., not restricted to MPQUIC and/or TLS). It is also desirable to enable secure NIN3A data connections without necessarily coupling them with a 3GPP access data connection (e.g., using an MA PDU).

In other words, an operator may wish to provide secure network connectivity services to WTRUs via untrusted non-3GPP access (e.g., Virtual Private Network (VPN) over public WiFi) without needing to deploy an N3IWF or use multi-access features such as ATSSS.

Solutions for NIN3A do not address the shared key (KUPF) lifecycle management aspects (e.g., how to re-key KUPF). For example, with solutions using a KUPF generated from a NAS key (e.g., KAMF) or from a key resulting from WTRU authentication (e.g., KAUSF), it may be necessary to re-run a NAS or authentication procedure to update the KUPF, leading to additional impacts on NFs (e.g., AMF, SMF, Authentication Server Function (AUSF)) and signaling overhead. Rekeying is needed to ensure fresh session keys are used between the WTRU and UPF, providing a level of forward secrecy so that past sessions are not compromised by future key compromises (e.g., decrypting past recorded communications). Currently, how to perform re-keying is not specified.

Based on the above, in various exemplary embodiments disclosed herein, secure and efficient NIN3A is provided with at least one of the following advantages: simpler architecture with reduced system impact and lightweight key lifecycle management, NIN3A support decoupled from ATSSS support to allow broader support (e.g., operator-provided VPN service over untrusted N3GPP), support for NIN3A in mobility and roaming scenarios, combinations of the same, or the like.

In certain representative embodiments, methods, architectures, apparatuses, systems, and mechanisms are provided where, for example, 5GS enables secure network access via non-integrated 3PP access (NIN3A) for a WTRU. The WTRU establishes a secure connection directly with the UPF via non-3PP access (e.g., using WiFi) without going through an intermediate network function (e.g., N3IWF). The WTRU establishes a secure connection directly with the UPF via non-3PP access using credentials (e.g., KNIN3A) generated from the 3GPP access credentials (e.g., KgNB). The key KNIN3A is generated by the WTRU and serving gNB during PDU session establishment over 3GPP access. The gNB sends the new KNIN3A to the UPF during the procedure. The secure connection between the WTRU and UPF may be established in a TLS or IKEv2 protocol using KNIN3A as a PSK.

The methods, architectures, apparatuses, systems, and mechanisms are described herein where the 5GS enables a WTRU and UPF to update the security of the NIN3A connection. A new key KNIN3A is generated by the WTRU and gNB (e.g., source or target gNB) during an inter-gNB handover procedure. The gNB sends a new KNIN3A to the UPF during the procedure. Upon receiving the new KNIN3A from the gNB, the UPF may initiate an update of connection security with the WTRU. This may be performed by UPF triggering re-keying of the session keys with the WTRU (e.g., based on previous KNIN3A) or by re-authenticating the WTRU using the new KNIN3A.

Provided herein are methods, architectures, apparatuses, systems, and mechanisms that allow the operator to provide robust NIN3A connection security enabled by leveraging 3GPP access security, in a simplified architecture i.e., without a deployed an intermediate NF (e.g., N3IWF). Using 3GPP handover network triggers to update the NIN3A connection security can provide automatic and/or frequent session keys re-keying or re-authentication to ensure forward secrecy for the communications over the NIN3A connection. This allows the network to control the amount of protected communication data using the same keys over time. For example, this allows to mitigate and/or limit the amount of compromised data in the case of the security keys being compromised.

The methods, architectures, apparatuses, systems, and mechanisms to support secure NIN3A connection can be provided in conjunction with multi-access procedures such as with ATSSS (e.g., using an MA PDU session) or as a “standalone” NIN3A connection (e.g., using a single access PDU session with only NIN3A leg). For example, an operator may provide the user with an operator hosted VPN service used over untrusted non-3GPP access (e.g., using a public and/or hotel, airport WiFi). Such service may be provided as part of the mobile user subscription and used with or without an associated 3GPP access data connection (e.g., for steering, switching or splitting user traffic), as the latter may for example incur unwanted and/or excessive cellular data roaming charges.

FIGS. 4 and 5 illustrate architectures of systems to support secure NIN3A connectivity in different scenarios (e.g., local breakout or non-roaming, roaming), in accordance with certain representative embodiments. The key distribution is illustrated as well. FIG. 4 is a diagram illustrating an example of KNIN3A distribution in a local breakout or non-roaming scenario. FIG. 5 is a diagram illustrating an example of KNIN3A distribution in a roaming with NIN3A direct connection to home scenario.

FIG. 4 illustrates a system architecture 400 for NIN3A connectivity in a local breakout or non-roaming scenario. For example, FIG. 4 depicts a network architecture 400 including WTRU 415 and non-3GPP access network 420. For example, the WTRU 415 is connected to the non-3GPP access network 420 via an Nx interface. The system 400 includes a 3GPP access network 435, which includes nodes such as AMF 445, SMF 455, UPF 450, and PCF 460. These are connected by interfaces such as N4, N7, and N11. A data network 490 indicates an endpoint for data transmission.

In FIG. 4, one or more keys are used for NIN3A connectivity security. For example, KNIN3A and KNIN3A ID are shown. Also, for example, KNIN3A and KNIN3A ID are generated at the WTRU 415 and 3GPP RAN node (gNB) 435. In a first option (dotted line labeled “option1” in FIG. 4), the gNB 435 sends KNIN3A and KNIN3A ID to the UPF 450 via N3 interface (e.g., in a GTP-U new IE). In another option (dotted line labeled “option2” in FIG. 4), the gNB 435 sends the key and identifier via AMF 445 and SMF 455, which forwards it to UPF 450 via N4 interface. The generation and distribution of KNIN3A and KNIN3A ID may take place as part of a PDU session establishment, a handover procedure (e.g., inter-gNB HO) or during WTRU transition from CM-IDLE to CM-CONNECTED. The WTRU 415 and UPF 450 use the KNIN3A and KNIN3A ID to secure their connection over the non-3GPP access, for example, in an IKEv2 or TLS protocol, e.g., at IKEv2 and/or TLS client 417 of the WTRU 415 and/or at IKEv2 and/or TLS client 452 of the UPF 450.

FIG. 5 illustrates a system architecture 500 for NIN3A connectivity in a roaming scenario using a NIN3A direct connection to home network, in accordance with certain representative embodiments. Like functions in FIG. 5 are referenced with like reference numbers compared to those of FIG. 4 with differences described herein. One difference between the architecture 500 of FIG. 5 and the architecture 400 of FIG. 4 is that the secure NIN3A connection terminates at an H-UPF 551 in the home network. In a first option (labeled “option1”), the gNB 535 sends KNIN3A and KNIN3A ID to the H-UPF 551 via V-UPF 550, over N3 and/or N9 interfaces. In another option (labeled “option2”), the gNB 535 sends the key and its identifier via AMF 545, V-SMF 555 and H-SMF 557, which forwards it to H-UPF 551 via N4 interface (e.g., part of HPLMN 530). In yet another option (labeled “option3”), the gNB 535 sends the key and its identifier via AMF 545, V-SMF 555, which forwards (e.g., via N4 in Visited Public Land Mobile Network (VPLMN) 510) to the V-UPF 550, which then forwards to H-UPF 551 (e.g., via N9).

The choice between NIN3A connectivity with local breakout or home routed deployment above may, for example, depend on the roaming agreements between operators. In general, the connectivity with local breakout provides communications with lower latency leading potentially to better user experience, while the home operator keeps more control and visibility of the network resources usage when a home routed data service is used by the WTRU 515.

Multi-access capabilities (e.g., ATSSS) may be used in conjunction with a secure NIN3A connection. In that case, the N3 interface may carry data from the 3GPP access leg (at 535). If the NIN3A is not used in tandem with a 3GPP access data connection (e.g., “standalone” NIN3A connection), then the N3 interface may not be used to carry user traffic. In that case, N3 may (e.g., still) be used for control messaging between gNB 535 and UPF (e.g., transport of NIN3A key as per option 1) or may not be setup (e.g., transport of NIN3A key as per option 2). The WTRU that uses a “standalone” NIN3A connection gets access to home network service while minimizing or avoid incurring mobile data roaming charges for the roaming user (as shown in FIG. 5).

FIG. 6 is a diagram illustrating an example of a key hierarchy for NIN3A, in accordance with certain representative embodiments. FIG. 6 illustrates a key hierarchy 600 for a 5GS updated for the support of secure NIN3A connectivity. Details of higher levels of the hierarchy 600 are provided below. In summary, a new KNIN3A key 676 (e.g., and identifier) is generated at the gNB 672 and WTRU (e.g., at Mobile Equipment (ME) 674 on the WTRU side 604) from the KgNB 650 (bottom right part of FIG. 6).

KgNB (next hop (HP) 650 is the shared root of the security context between WTRU (e.g., at ME 662) and gNB 660 that secures communication over the air interface between the two. The KNIN3A 676 and/or KNIN3A ID is sent to UPF (at 672) by the gNB 672. For example, the KNIN3A and/or KNIN3A ID may be generated and transmitted during PDU session establishment and/or modification, or handover procedure.

The WTRU and UPF use KNIN3A as a PSK in mutual authentication and key agreement protocol. The authentication and key exchange methods used, including generation of the session keys and security keys (not shown in FIG. 6), depends on the security protocol used between the WTRU and UPF (e.g., IPSec Security Association (SA), Child SA with IKEv2, session and traffic keys in TLS 1.3). The security protocol supported may be indicated by the WTRU (e.g., with IKEv2 and/or TLS client functionality) to network prior or during PDU session establishment. The network (SMF) may select a UPF with appropriate capabilities and or configuration (e.g., with IKEv2 and/or TLS server functionality).

In certain representative embodiments, the key hierarchy 600 includes, in general, a network side 602 and a WTRU side 604 across six layers, with three layers as part of HPLMN 606 and three layers as part of Serving Network 608. For example, the key hierarchy 600 is provided for 5GS updated for secure NIN3A connectivity. Also, for example, the key hierarchy 600 is divided into two main parts: the HPLMN 606 and the Serving Network 608, each, for example, with three layers. Further, for example, in the HPLMN 606, the first layer involves a key shared between the Unified Data Management (UDM) and/or Authentication Credential Repository and Processing Function (ARPF) and the Universal Subscriber Identity Module (USIM) of the WTRU, which is used to derive the Ciphering Key (CK) and Integrity Key (IK). In addition, for example, the second layer includes the 5G Authentication and Key Agreement (AKA) on the network side and the Extensible Authentication Protocol-Authentication and Key Agreement (EAP-AKA′) on the WTRU side. Moreover, for example, the third layer involves the Authentication Server Function (AUSF) and the ME, with keys such as KAUSF and CK′, IK′ derived from the CK, IK. Furthermore, for example, in the Serving Network, the first layer involves the Security Anchor Function (SEAF) and the ME, with KAMF derived from KSEAF. Additionally, for example, the second layer includes the Access and Mobility Management Function (AMF) and the ME, with keys such as KN3IWF, KgNB, NH, KNASint, and KNAsenc derived from KAMF. Still further, for example, the third layer involves the Non-3GPP Interworking Function (N3IWF), gNB, and gNB and/or UPF on the network side, and the ME on the WTRU side, with keys such as KN3IWF, KRRCint, KRRCenc, KUPint, and KUPenc derived from KgNB, NH.

For example, the KNIN3A (e.g., 676) key is generated at the gNB (e.g., 672) and the WTRU (e.g., at 674) from the KgNB (e.g., 650). Also, for example, the KNIN3A (e.g., 676) key is used as a Pre-Shared Key in mutual authentication and key agreement protocols between the WTRU and UPF, with the specific security protocol determining the session and traffic keys. Further, for example, the KNIN3A (e.g., 676) key is used to establish a secure connection between the WTRU and the UPF over NIN3A.

In a first layer of the HPLMN 606, between the network side 602 and the WTRU side 604, a key 612 is provided between Unified Data Management (UDM) and/or Authentication Credential Repository and Processing Function (ARPF) 610 and Universal Subscriber Identity Module (USIM) 614 of the WTRU. A ciphering key (CK), Integrity Key (IK) are based on the key 612.

In a second layer of the HPLMN 606, between the network side 602 and the WTRU side 604, UDM and/or ARPF 618 includes 5G Authentication and Key Agreement (AKA) 622 and ME 620 includes Extensible Authentication Protocol-Authentication and Key Agreement (EAP-AKA′) 626.

In a third layer of the HPLMN 606, between the network side 602 and the WTRU side 604, AUSF 630 also includes the 5G AKA 622 and ME 632 includes the EAP-AKA′ 626.

Between the second and third layers of the HPLMN 606, KAUSF 624 is based on the CK, IK 616 in accordance with the 5G AKA 622. Also, between the second and third layers of the HPLMN 606, CK′, IK′ 628 is based on the CK, IK 616 in accordance with the EAP-AKA′ 626. Further, KAUSF 634 is based on CK′, IK′ 628 in accordance with the EAP-AKA′ 626. Further, KSEAF 636 is based on the KAUSF 624 and the KAUSF 634.

In a first layer of the Serving Network 608, between Security Anchor Function (SEAF) 638 on the network side 602 and ME 640 on the WTRU side 604, KAMF 642 is based on the KSEAF 636.

In a second layer of the Serving Network 608, between AMF 644 on the network side 602 and ME 646 on the WTRU side 604, each of KN3IWF 648, KgNB, NH 650, KNASint 652, and KNAsenc 654 are based on the KAMF 642.

In a third layer of the Serving Network 608, the KN3IWF 648 is utilized between N3 IWF 656 on the network side 602 and ME 658 on the WTRU side 604. Also, in the third layer of the Serving Network 608, between gNB 660 on the network side 602 and ME 662 on the WTRU side 604, each of KRRCint 664, KRRCenc 666, KUPint 668, and KUPenc 670 is based on KgNB, NH 650. Further, in the third layer of the Serving Network 608, between gNB and/or UPF 675 on the network side 602 and ME 674 on the WTRU side 604, as noted above, the KNIN3A 676 is based on the KgNB, NH 650.

FIG. 7A is a first portion of a sequence diagram illustrating a first portion of an example of a NIN3A connection security setup using 3GPP Access Security. FIG. 7B is a second portion of the sequence diagram illustrating a second portion of the example of the NIN3A connection security setup using the 3GPP Access Security.

FIGS. 7A-7B illustrate a procedure 700 to establish a secure NIN3A connection between WTRU 715 and UPF 750 based on 3GPP access security, during PDU session establishment, in accordance with certain representative embodiments. The WTRU 715 utilizes the shared security key (KNIN3A) for the direct connection with the UPF 750 over NIN3A based on its existing 3GPP access security association (KgNB). The serving gNB 735 provides the UPF 750 with the KNIN3A utilized based on the existing security association between the WTRU 715 and gNB 735 (KgNB). After successful PDU session establishment for the NIN3A connection, WTRU 715 and UPF 750 perform a mutual authentication and connection security establishment using KNIN3A as a PSK in a security protocol (e.g., IKEV2 or TLS). The procedure 700 includes at least one of Steps 0 through 12 below, combinations of the same, or the like.

Step 0: The WTRU 715 is registered to the network and securely connected via gNB 735 with which it shares a KgNB. The WTRU 715 may indicate secure NIN3A connectivity capabilities in the Registration Request message.

For example, the WTRU 715 establishes a connection with a non-3GPP access 720 (e.g., WiFi AP). The WTRU 715 may be provisioned with UE Route Selection Policy (URSP) rules such as to trigger the WTRU 715 to request a secure NIN3A connectivity upon application request (e.g., when launched by the user on the WTRU 715). For example, the WTRU 715 may match a (e.g., VPN client) application request with one or more Traffic Descriptors in a URSP rule such as an Operating System Identifier (OSId) and an Operating System Specific Application Identifier (OSAppId) corresponding to the application, or the like. For example, the WTRU 715 may match the application request with one or more Route Descriptors in a URSP rule such as Single Network Slice Selection Assistance Information (S-NSSAI), Data Network Name (DNN) (e.g., dedicated for NIN3A connectivity), access type preference (e.g., non-3GPP), or the like.

Step 1: The WTRU 715 sends a request message over 3GPP access to the network to setup a PDU session with secure NIN3A connection support. The WTRU 715 may include an indication that the request is for NIN3A connectivity, an indication of 3GPP utilized NIN3A security capability, an indication of standalone NIN3A connection, PDU session ID, or the like. The security capability may indicate the security protocol(s) supported by the WTRU 715 (e.g., IKEv2, TLS 1.3). The WTRU 715 may include an indication for always-on PDU session. The indication may be used by the network to determine how to allocate UP resources allocation as described herein. The NIN3A connectivity indication may be included in the UL NAS transport part of the message.

Step 2: The AMF 745 selects an SMF 755 that supports PDU session with NIN3A connectivity based on the NIN3A connectivity parameters and forwards the parameters to the SMF 755. The AMF 745 may decide to include the WTRU 715 location information used to assist the SMF 755 to select an optimal UPF 750 based the NIN3A connectivity indication.

Step 3: Upon receiving the above NIN3A connectivity parameters from AMF 745, the SMF 755 checks that the PDU session with NIN3A connectivity is allowed based on Session Management subscription data and sends a response to AMF 745 accordingly.

Step 4: If dynamic Policy Control and Charging (PCC) is used, SMF 755 requests a policy association creation indicating a NIN3A connection and security capabilities for the connection. The SMF 755 receives PCC rules from the PCF 760 indicating NIN3A connection security control information. The rules may indicate criteria for NIN3A connection security update such as the frequency or triggers based on which the sessions keys need to be updated or the WTRU 715 needs to be re-authenticated. An example of trigger may be based on a time duration, indicating for example the maximum time for which security keys can be used for a given session over the NIN3A connection between WTRU 715 and UPF 750. When that maximum time duration is passed the UPF 750 may decide to perform an update of the session keys with the WTRU 715. Another trigger example may be based on data volume limit that can be exchanged between the WTRU 715 and UPF 750 before changing the keys. Past a given data volume limit the UPF 750 may decide to perform an update of the session keys with the WTRU 715. Yet another example may be based on signaling from RAN (not shown in FIGS. 7A-7B) and/or SMF 755 which may indicate a WTRU 715 mobility event (e.g., following connected or idle mobility as described herein), a new generated KNIN3A key or the KNIN3A key being revoked (e.g., based on subscription update). The PCF 760 may indicate to the SMF 755 the security protocol supported (e.g., IKEv2, TLS 1.3) which the PCF 760 may determine based on subscription information and/or operator policy. The SMF 755 may obtain WTRU 715 location information from the AMF 745 (e.g., by subscribing to WTRU 715 location information updates and/or receiving the location info as in step 2).

Step 5: The SMF 755 selects a UPF 750 with support for secure NIN3A connection. The SMF 755 may use WTRU 715 location information to select the UPF 750 that is most suitable to server the WTRU 715 (e.g., local UPF 750 relative to the non-3GPP access 720 and/or WTRU 715 location). The SMF 755 sends a request (e.g., at Step 5a) to the UPF 750 for N4 session setup with an indication for secure NIN3A connection, NIN3A connection security handling rules, or the like. The UPF 750 sends a response (e.g., at Step 5b) to the request. Based on the supported security protocol, the SMF 755 may instruct to start the security end point functionality (e.g., IKEv2 or TLS server). The UPF 750 may start the corresponding functionality by listening on the appropriate port(s) (e.g., IPSec UDP port 500, HTTPs port 443, or the like). The UPF 750 provides SMF 755 with the UPF 750 addressing info for the NIN3A connection (e.g., IP address, port number, or the like). The SMF 755 may instructs the UPF 750 whether a N3 tunnel setup is needed. The decision to not use an N3 tunnel may be determined based on the standalone NIN3A connection indication. The N3 tunnel may be setup for the purpose of exchanging control messaging between RAN and UPF 750 (e.g., trigger to re-key the NIN3A connection). If N3 tunnel is to be used UPF 750 provides tunnel endpoint information (e.g., CN tunnel info) to SMF 755. The UPF 750 associates the N3 tunnel end point (TEID) and/or the N4 session with secure NIN3A connection termination functionality.

Step 6: The SMF 755 sends to gNB 735 via AMF 745 a message (e.g., N2 SM info) information for the PDU session including the PDU session ID with secure NIN3A connection support indication, UPF CN tunnel info corresponding to N3 interface with the UPF 750 serving the NIN3A session, indication of standalone NIN3A connection or indication to not allocate radio resources for the PDU session. The message includes response from SMF 755 to the WTRU 715.

Step 7: The gNB 735 receives (e.g., at Step 7a) a message directly or indirectly from SMF 755 (e.g., N2 SM info) including PDU session ID with secure NIN3A connection support indication, CN tunnel info corresponding to the UPF 750 serving the NIN3A session, indication of standalone NIN3A connection or indication to not allocate radio resources for the PDU session, or the like.

Based on presence of the indication of standalone NIN3A connection the gNB 735 may refrain from allocating resources for data communication over the air interface (e.g., DRB) for the PDU session.

Based on indication from SMF 755, gNB 735 may refrain to use N3 interface or restrict usage to network internal “control” messaging (e.g., using GTP-U header or new IE(s)) such as for transmitting key material (KNIN3A) to UPF 750.

Based on the indication of NIN3A connection, the gNB 735 generates a new KNIN3A and KNIN3A ID using current KgNB. As part of the generation the gNB 735 may use any of the following input parameters: the PDU session ID, a number value (e.g., random number, sequence number such as Next Hop Chaining Counter parameter (NCC)), or the like. Deriving (e.g., at Step 7b) a KNIN3A from current KgNB ensures that a fresh NIN3A key is always available to setup or update the security for the NIN3A connection between the WTRU 715 and UPF 750 (e.g., following a WTRU 715 PDU session establishment, WTRU 715 mobility and/or WTRU 715 RRC and/or CM state transition, or the like).

Step 8: The WTRU 715 receives from the SMF 755 a response (e.g., at Step 8a) including an indication of acceptance for NIN3A connection for the PDU session ID and addressing information for the secure NIN3A connection termination at UPF 750 (e.g., IP address, port number, or the like). The WTRU 715 generates (e.g., or derives) (e.g., at Step 8b) KNIN3A and KNIN3A ID similarly to gNB 735 at step 7. The WTRU 715 stores the new KNIN3A and KNIN3A ID along with the UPF NIN3A connection termination information for the PDU session.

Step 9: The gNB 735 sends a response to AMF 745. The response may include gNB 735 N3 tunneling info corresponding to CN Tunnel Info received in step 7. The response may include NIN3A key material for SMF 755 to forward to UPF 750 as described in step 11.

Step 10: The gNB 735 sends to the UPF 750 over N3 (e.g., in a GTP-U Information element) the new KNIN3A and KNIN3A ID. The UPF 750 locates the N4 session context associated with the N3 message TEID, checks that N4 session is associated with secure NIN3A connection functionality and stores the new KNIN3A and KNIN3A ID as part of the NIN3A connection security context.

Step 11: As an alternative to sending NIN3A key material directly to UPF 750 via N3, the gNB 735 may send the new KNIN3A and KNIN3A ID in step 9 via AMF 745 and SMF 755 (e.g., at Steps 11a and 11d), which forwards to UPF 750 (e.g., at Steps 11b and 11c).

Step 12: The WTRU 715 establishes a secure connection with the UPF 750 over NIN3A at the address info and based on UPF 750 supported security protocol as provided by SMF 755 at step 8. The WTRU 715 performs a mutual authentication with UPF 750 and generates session and security keys based on KNIN3A (e.g., with TLS or IKEv2 using KNIN3A as PSK, or the like).

As part of the authentication and key exchange protocol the WTRU 715 transmits the KNIN3A ID to the UPF 750 to locate the KNIN3A key to be used to secure the NIN3A session. The KNIN3A ID may be sent in the clear (e.g., in initial messages) when establishing a new NIN3A connection. Potential privacy attacks using the transmitted KNIN3A ID to try tacking the WTRU 715 are however mitigated thanks to the WTRU 715 generating a new random KNIN3A ID when configuring a new PDU session for NIN3A connectivity as described herein or during WTRU 715 state transitions and/or mobility procedures (described herein).

In some cases, the WTRU 715 may start to send the first uplink packets towards the UPF 750 (e.g., to initiate the secure IPSec or TLS connection, after step 8) before the UPF 750 receives the new KNIN3A and KNIN3A ID. The UPF 750 may receive one or more packets from an unauthorized source at its NIN3A connection termination point. If the UPF 750 receives a packet for a NIN3A connection for which it does not find a valid NIN3A connection security context it may discard or reject the connection request. The (e.g., legitimate) WTRU 715 that is authorized for NIN3A connectivity may then retry based on the security protocol specific retry and/or backoff mechanism (e.g., IPSec or TLS).

FIG. 8A is a first portion of a sequence diagram illustrating a first portion of an example of a NIN3A security update during an inter-gNB handover. FIG. 8B is a second portion of the sequence diagram illustrating a second portion of the example of the NIN3A security update during the inter-gNB handover.

FIGS. 8A-8B illustrate a procedure 800 to update the security for NIN3A connection (e.g., at non-3GPP access 820) between the WTRU 815 and UPF 860 based on updated 3GPP access security during a handover procedure, in accordance with certain representative embodiments. During the procedure, a target gNB 837 and WTRU 815 generate a new KNIN3A based on new KgNB for applicable PDU session identified as using NIN3A connection. The target gNB 837 provides UPF 860 with NIN3A connection shared key (KNIN3A) directly (e.g., via N3) or via SMF 755 (e.g., N4). After successful completion of the handover procedure UPF 860 may initiate a re-keying of NIN3A session keys or re-authenticate the WTRU 815 using the of new KNIN3A (e.g., using IKEv2 or TLS specific re-keying or re-authentication methods, or the like). The procedure 800 includes at least one of Steps 0 through 5 below, combinations of the same, or the like.

Step 0: The WTRU 815 has established a PDU session with NIN3A connectivity as described above.

Step 1: A source gNB 835 initiates handover preparation (e.g., based on radio signal measurements) and generates a new KgNB.

Step 2: The source gNB 835 sends a handover request (e.g., at Step 2a) to the target gNB 837 indicating one or more PDU sessions to be transferred, the new KgNB, or the like. The source gNB 835 includes a NIN3A support indication for each of the one or more PDU sessions where applicable.

The target gNB 837 generates (or derives) (e.g., at Step 2b) a new KNIN3A, KNIN3A ID, or the like using the new KgNB as described above for each of the applicable PDU sessions (e.g., accepted by target gNB 837 and with NIN3A connectivity). Alternatively, the source gNB 835 may generate the KNIN3A, KNIN3A ID, or the like and provide them to the target gNB 837. The target gNB 837 may discard the KNIN3A, KNIN3A ID, or the like, for the PDU sessions that it does not accept for the handover.

The target gNB 837 acknowledges (e.g., at Step 2c) the handover to the source gNB 835.

Step 3: During the RRC configuration, for example, based on a handover command or request (e.g., at Step 3a), the WTRU 815 generates (e.g., or derives) (e.g., at Step 3b) a new KgNB. For each PDU session used for secure NIN3A and handed over to the target gNB 837, the WTRU 815 generates (e.g., or derives) (e.g., at Step 3c) a new KNIN3A and KNIN3A ID as described above and replaces the previously stored KNIN3A and KNIN3A ID for the PDU session. WTRU 815 confirms (e.g., at Step 3d) completion of the procedure towards the target gNB 837.

Step 4: The target gNB 837 proceeds with the rest of handover completion steps. Target gNB 837 sends to the serving UPF 860 the KNIN3A and KNIN3A ID directly (as shown in FIGS. 7A-7B) or via AMF 845 and/or SMF 855 (e.g., in N2 Path Switch Request, Nsmf_PDUSession_UpdateSMContext Request, or the like) (e.g., at Steps 4a-4f).

Step 5: The UPF 860 upon receiving a trigger from gNB or SMF 855 determines whether to initiate a re-keying for the NIN3A connection or re-authenticate the WTRU 815. The UPF 860 may make the determination based on the NIN3A connection control information (e.g., rules) provided by SMF 855 as described above. For example, the UPF 860 may use timing and/or data volume criteria before initiating a re-key such as to avoid or throttle initiation of too frequent re-keying with the WTRU 815. The UPF 860 may decide to skip, defer or initiate re-keying or re-authentication of the WTRU 815 using the new KNIN3A key based on NIN3A connection control information.

The mechanism for NIN3A connection security update is similar in the case of N2 handover (i.e., where no Xn interface exists between the source gNB 835 and the target gNB 837, or the like), with the difference that the target gNB 837 receives the new KgNB from AMF 845 (e.g., instead of source gNB 835), as per existing N2 based handover procedure. The target gNB 837 generates KNIN3A using the KgNB as described above. Target gNB 837 transmits KNIN3A and/or KNIN3A ID to UPF 860 directly or via AMF 845 and/or SMF 855. The WTRU 815 generates the KNIN3A using the KgNB generated during the RRC configuration procedure with the source gNB 835 as described above.

NIN3A Connection Security Update during WTRU 815 transition from CM-IDLE to CM-CONNECTED In this scenario, the WTRU 815 in a CM-IDLE state has no active 3GPP access security context (KgNB) assumed to have been released when the WTRU 815 previously transitioned from CM-CONNECTED to CM-IDLE. The PDU session using the NIN3A connection may however remain active while the WTRU 815 is in CM-IDLE on the 3GPP access leg. For WTRU 815 and UPF 860 may actively exchange data over the secure NIN3A connection established as described above while the WTRU 815 in CM-IDLE.

In the NIN3A connection setup described above, the WTRU 815 may request the PDU session using NIN3A connection and include an indication for an always-on PDU session. The network may grant the PDU session to be always-on based on the indication or based on the PDU session using a (e.g., standalone) NIN3A connection and/or network policy. The difference with a conventional always-on PDU session is that user plane resources for the 3GPP access leg may not need to be setup, as described above. For example, the N3 tunnel between the gNB and UPF 860 may not need to be setup when transitioning from CM-IDLE to CM-CONNECTED for a PDU session using a (e.g., standalone) NIN3A connection. Consequently, the SMF 855 determines to not provide an inactivity timer to the UPF 860 since the PDU session is using a (e.g., standalone) NIN3A connection and/or the PDU session is an always-on PDU session.

The WTRU 815 sends a service request procedure by including the PDU session that uses a NIN3A connection regardless of if there is no pending DL or UL data to be exchanged over 3GPP access leg (e.g., service request for the purpose of establish a signaling connection) by virtue of the PDU session using (e.g., standalone) NIN3A connection and/or being always-on PDU session. The WTRU 815 lists the PDU session with NIN3A connection which allows the network to identify the PDU sessions for which an update of the NIN3A connection security may be triggered between the UPF 860 and WTRU 815 (e.g., by sending a new KNIN3A to UPF 860 to trigger re-keying or re-authentication, or the like). The WTRU 815 and gNB generate a new KgNB as part of the RRC Connection Reconfiguration procedure triggered as part of the service request procedure and WTRU 815 and gNB generate a new KNIN3A for the PDU session using a NIN3A connection. Following the successful RRC Connection Reconfiguration procedure the gNB sends the new KNIN3A to UPF 860 via SMF 855 (e.g., over N4) or directly (e.g., over N3) as described above. The UPF 860 may trigger a re-authentication of the WTRU 815 upon receiving new KNIN3A. The UPF 860 may initiate a re-keying for the connection with WTRU 815 based on receiving the new key or indication to rekey from gNB and/or SMF 855.

FIG. 9 is a procedural diagram illustrating an example procedure, performed by a wireless transmit and/or receive unit (WTRU), for configuring a secure non-3GPP connection between the WTRU and a wireless network.

In certain representative embodiments, a process 900, is performed by a wireless transmit and/or receive unit (WTRU), for configuring a secure non-3GPP connection between the WTRU and a wireless network based at least in part on existing 3GPP access credentials shared between the WTRU and the wireless network. For example, the process 900 includes transmitting 910, to the wireless network, first information comprising a request to establish a protocol data unit (PDU) session and information for enablement of the secure non-3GPP connection for the PDU session. Also, for example, the process 900 includes receiving 920, from the wireless network, second information comprising an indication of acceptance of the secure non-3GPP connection enablement for the PDU session. Further, for example, the process 900 includes, based at least in part on the indication of acceptance of the secure non-3GPP connection enablement, generating 930 new security credentials for the secure non-3GPP connection based at least in part on the existing 3GPP access credentials. In addition, for example, the process 900 includes establishing 940 the secure non-3GPP connection for the PDU session with the wireless network based at least in part on the new security credentials. Moreover, for example, the secure non-3GPP connection is made directly to a user plane function (UPF) of the wireless network. Furthermore, for example, the first information includes an indication of 3GPP non-3GPP security capability, and an indication of one or more security protocols supported by the WTRU. Additionally, for example, the first information includes an indication of a standalone secure non-3GPP connection. Still further, for example, the second information includes: an indication of a secure non-3GPP connection termination at a user plane function (UPF) of the wireless network, and an indication of one or more security protocols supported by the wireless network. Even further, for example, the generating the new security credentials for the secure non-3GPP connection based at least in part on the existing 3GPP access credentials includes generating a new shared key for secure non-3GPP connectivity and an identifier for the new shared key based at least in part on a shared key of a node of the wireless network (KgNB). Even further, for example, the process 900 includes, e.g., for a handover from a source node of the wireless network to a target node of the wireless network: receiving, from the wireless network, a request to update 3GPP access credentials; and based at least in part on the updated 3GPP access credentials, generating updated security credentials to be used for the secure non-3GPP connection.

In certain representative embodiments, a wireless transmit and/or receive unit (WTRU) is configured to perform one or more portions of the process 900. For example, the WTRU includes a processer, and a transceiver coupled to the processer. Also, for example, the WTRU is to: transmit, to the wireless network, first information comprising a request to establish a protocol data unit (PDU) session and information for enablement of the secure non-3GPP connection for the PDU session. Further, for example, the WTRU is to: receive, from the wireless network, second information comprising an indication of acceptance of the secure non-3GPP connection enablement for the PDU session. In addition, for example, the WTRU is to: based at least in part on the indication of acceptance of the secure non-3GPP connection enablement, generate new security credentials for the secure non-3GPP connection based at least in part on the existing 3GPP access credentials. Moreover, for example, the WTRU is to: establish the secure non-3GPP connection for the PDU session with the wireless network based at least in part on the new security credentials. Furthermore, for example, the secure non-3GPP connection is made directly to a user plane function (UPF) of the wireless network. Additionally, for example, the first information includes: an indication of 3GPP security capability for the secure non-3GPP connection, and an indication of one or more security protocols supported by the WTRU. Still further, for example, the first information includes an indication of a standalone secure non-3GPP connection. Even further, for example, the second information includes: an indication of a secure non-3GPP connection termination at a user plane function (UPF) of the wireless network, and an indication of one or more security protocols supported by the wireless network. Yet further, for example, to generate the new security credentials for the secure non-3GPP connection based at least in part on the existing 3GPP access credentials. For example, the WTRU is further to generate a new shared key for secure non-3GPP connectivity and an identifier for the new shared key based at least in part on a shared key of a node of the wireless network (KgNB). Also, for example, for a handover from a source node of the wireless network to a target node of the wireless network, the WTRU is further to: receive, from the wireless network, a request to update 3GPP access credentials; and based at least in part on the updated 3GPP access credentials, generate updated security credentials to be used for the secure non-3GPP connection.

FIG. 10 is a procedural diagram illustrating an example procedure, performed at a user plane function (UPF) of a wireless network, for configuring a secure non-3GPP connection between a wireless transmit and/or receive unit (WTRU) and the wireless network.

In certain representative embodiments, a process 1000 is performed at a user plane function (UPF) of a wireless network for configuring a secure non-3GPP connection between a wireless transmit and/or receive unit (WTRU) and the wireless network based at least in part on existing 3GPP access credentials shared between the WTRU and the wireless network. For example, the process 1000 includes receiving 1010, from an SMF of the wireless network, first information comprising a request to establish a data path for a protocol data unit (PDU) session, including secure non-3GPP connection information. Also, for example, the process 1000 includes transmitting 1020, to the SMF of the wireless network, and based at least in part on the first information, second information comprising an indication of acceptance of the secure non-3GPP connection enablement for the PDU session. Further, for example, the process 1000 includes receiving 1030, directly from the node of the wireless network or via the SMF of the wireless network, new security credentials for the secure non-3GPP connection based at least in part on the existing 3GPP access credentials. In addition, for example, the process 1000 includes establishing 1040 the secure non-3GPP connection between the WTRU and the wireless network based at least in part on the new security credentials. Moreover, for example, the secure non-3GPP connection is made directly to the UPF of the wireless network. Furthermore, for example, the first information includes: an indication of 3GPP security capability for the secure non-3GPP connection, and an indication of one or more security protocols supported by the WTRU. Additionally, for example, the first information includes an indication of a standalone secure non-3GPP connection. Still further, for example, the second information includes: an indication of a secure non-3GPP connection termination at the UPF of the wireless network, and an indication of one or more security protocols supported by the wireless network. Even further, for example, the new security credentials for the secure non-3GPP connection based at least in part on the existing 3GPP access credentials include: a new shared key for secure non-3GPP connectivity and an identifier for the new shared key generated based at least in part on a shared key of a node of the wireless network (KgNB). Yet further, for example, the process 1000 includes, for a handover from a source node of the wireless network to a target node of the wireless network: receiving, from the wireless network, security credentials to be used for the secure non-3GPP connection.

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

Each of the contents of the following references is incorporated by reference herein in their entireties: (1) 3GPP TS 23.501, “System Architecture for the 5G System (5GS); Stage 2,” v19.0.0, 2023; (2) 3GPP TS 23.502, “Procedures for the 5G System (5GS); Stage 2,” v19.0.0, 2023; (3) 3GPP TR 23.700-54, “Study on Application Architecture for Enabling Edge Applications,” v1.0.0, 2023; (4) 3GPP TR 33.754, “Study on Security Aspects of 5G System Enhancements,” v0.2.0, 2023; (5) IETF RFC 5996, “Internet Key Exchange Protocol Version 2 (IKEv2),” 2010; (6) IETF RFC 8446, “The Transport Layer Security (TLS) Protocol Version 1.3,” 2018; and (7) 3GPP TS 24.526, “IMS Multimedia Telephony Service and Supplementary Services; Stage 3,”v18.7.0, 2023.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6, 35 U.S.C. § 112(f) or means-plus-function claim format, and any claim without the terms “means for” is not so intended.

What is claimed:

1. A method, performed by a wireless transmit and/or receive unit (WTRU), for configuring a secure non-3GPP connection between the WTRU and a wireless network based at least in part on existing 3GPP access credentials shared between the WTRU and the wireless network, the method comprising:
transmitting, to the wireless network, first information comprising a request to establish a protocol data unit (PDU) session and information for enablement of the secure non-3GPP connection for the PDU session;
receiving, from the wireless network, second information comprising an indication of acceptance of the secure non-3GPP connection enablement for the PDU session;
based at least in part on the indication of acceptance of the secure non-3GPP connection enablement, generating new security credentials for the secure non-3GPP connection based at least in part on the existing 3GPP access credentials; and
establishing the secure non-3GPP connection for the PDU session with the wireless network based at least in part on the new security credentials.

2. The method of claim 1, wherein the secure non-3GPP connection is made directly to a user plane function (UPF) of the wireless network.

3. The method of claim 1, wherein the first information comprises:
an indication of 3GPP security capability for the secure non-3GPP connection; and
an indication of one or more security protocols supported by the WTRU.

4. The method of claim 1, wherein the first information comprises an indication of a standalone secure non-3GPP connection.

5. The method of claim 1, wherein the second information comprises:
an indication of a secure non-3GPP connection termination at a user plane function (UPF) of the wireless network; and
an indication of one or more security protocols supported by the wireless network.

6. The method of claim 1, wherein the generating the new security credentials for the secure non-3GPP connection based at least in part on the existing 3GPP access credentials comprises:
generating a new shared key for secure non-3GPP connectivity and an identifier for the new shared key based at least in part on a shared key of a node of the wireless network (KgNB).

7. The method of claim 1, further comprising, for a handover from a source node of the wireless network to a target node of the wireless network:
receiving, from the wireless network, a request to update 3GPP access credentials; and
based at least in part on the updated 3GPP access credentials, generating updated security credentials to be used for the secure non-3GPP connection.

8. A method, performed at a user plane function (UPF) of a wireless network, for configuring a secure non-3GPP connection between a wireless transmit and/or receive unit (WTRU) and the wireless network based at least in part on existing 3GPP access credentials shared between the WTRU and the wireless network, the method comprising:
receiving, from a session management function (SMF) of the wireless network, first information comprising a request to establish a data path for a protocol data unit (PDU) session with the wireless network and secure non-3GPP connection information;
transmitting, to the SMF of the wireless network, and based at least in part on the first information, second information comprising an indication of acceptance of the secure non-3GPP connection enablement for the PDU session;
receiving, directly from the node of the wireless network or via the SMF of the wireless network, new security credentials for the secure non-3GPP connection based at least in part on the existing 3GPP access credentials; and
establishing the secure non-3GPP connection with the WTRU based at least in part on the new security credentials.

9. The method of claim 8, wherein the secure non-3GPP connection is made directly to the WTRU.

10. The method of claim 8, wherein the first information comprises:
an indication of 3GPP security capability for the secure non-3GPP connection; and
an indication of one or more security protocols supported by the WTRU.

11. The method of claim 8, wherein the first information comprises an indication of a standalone secure non-3GPP connection.

12. The method of claim 8, wherein the second information comprises:
an indication of a secure non-3GPP connection termination at the UPF of the wireless network; and
an indication of one or more security protocols supported by the wireless network.

13. The method of claim 8, wherein the new security credentials for the secure non-3GPP connection based at least in part on the existing 3GPP access credentials include:
a new shared key for secure non-3GPP connectivity and an identifier for the new shared key generated based at least in part on a shared key of a node of the wireless network (KgNB).

14. The method of claim 8, further comprising, for a handover from a source node of the wireless network to a target node of the wireless network:
receiving, from the wireless network, security credentials to be used for the secure non-3GPP connection.

15. A wireless transmit and/or receive unit (WTRU) comprising:
a processer; and
a transceiver coupled to the processer, wherein the WTRU is to:
transmit, to a wireless network, first information comprising a request to establish a protocol data unit (PDU) session and information for enablement of the secure non-3GPP connection for the PDU session;
receive, from the wireless network, second information comprising an indication of acceptance of the secure non-3GPP connection enablement for the PDU session;
based at least in part on the indication of acceptance of the secure non-3GPP connection enablement, generate new security credentials for the secure non-3GPP connection based at least in part on the existing 3GPP access credentials; and
establish the secure non-3GPP connection for the PDU session with the wireless network based at least in part on the new security credentials.

16. The WTRU of claim 15, wherein the first information comprises:
an indication of 3GPP security capability for the secure non-3GPP connection; and
an indication of one or more security protocols supported by the WTRU.

17. The WTRU of claim 15, wherein the first information comprises an indication of a standalone secure non-3GPP connection.

18. The WTRU of claim 15, wherein:
the secure non-3GPP connection is made directly to a user plane function (UPF) of the wireless network, and
the second information comprises:
an indication of a secure non-3GPP connection termination at the UPF of the wireless network; and
an indication of one or more security protocols supported by the wireless network.

19. The WTRU of claim 15, wherein, to generate the new security credentials for the secure non-3GPP connection based at least in part on the existing 3GPP access credentials, the WTRU is further to:
generate a new shared key for secure non-3GPP connectivity and an identifier for the new shared key based at least in part on a shared key of a node of the wireless network (KgNB).

20. The WTRU of claim 15, wherein, for a handover from a source node of the wireless network to a target node of the wireless network, the WTRU is further to:
receive, from the wireless network, a request to update 3GPP access credentials; and
based at least in part on the updated 3GPP access credentials, generate updated security credentials to be used for the secure non-3GPP connection.
